(19) United States
(12) Patent Application Publication
(10) Pub. No.: US 2015/0287302 A1
(43) Pub. Date: Oct. 8, 2015

(54) SAFETY REPORTING NETWORK AND METHOD FOR OPERATING THE SAFETY REPORTING NETWORK

(71) Applicant: ROBERT BOSCH GMBH, Stuttgart (DE)

(72) Inventors: Kilian Ruess, Riemerling (DE); Andreas Baumann, Muenchen (DE); Michael Guertner, Hoehenkirchen-Siegertsbrunn (DE)

(21) Appl. No.: 14/430,394

(22) PCT Filed: Sep. 20, 2013
(86) PCT No.: PCT/EP2013/069630

§ 371 Date: Mar. 23, 2015

(30) Foreign Application Priority Data
Sep. 24, 2012 (DE) 10 2012 217 127.4

(51) Int. Cl. G08B 13/196

(52) U.S. Cl. CPC G08B 13/19656; G08B 13/19697

(57) ABSTRACT

The invention relates to a safety reporting network 1 having a local area monitoring network 2 for a monitoring object 3, wherein the at least one local area monitoring network 2 has at least one monitoring camera 7, wherein the monitoring camera 7 is designed to output an event notice E, having a first network 5 and a central safety control device 13, wherein the local area monitoring network 2 is connected to the central safety control device 13 via the first network 5 for the purpose of data interchange, wherein the event notice E is transmitted to the central safety control device 13 via the first network 5, having a second network 18 and at least one agent device 19 that is connected to the central safety control device 13 via the second network 18, wherein the event notice E or an event notice E′ processed on the basis of the event notice is transmitted to the agent device 19 as an alarm notice A, wherein the safety reporting network 1 has a plurality of local area monitoring networks 2, wherein the plurality of local area monitoring networks 2 are associated with different monitoring objects 3.

### BACKGROUND OF THE INVENTION

The invention relates to a safety reporting network.

To monitor buildings and other spacious areas, monitoring cameras are often used. In the simplest case, precisely one monitoring camera is provided in a monitoring area, its image data being forwarded to a monitoring center and are checked there. In more complex monitoring areas, a multiplicity of monitoring cameras is usually installed. The image datastreams of the monitoring cameras are often brought together in a monitoring center where they are checked by monitoring personnel.

The printed document DE 10 2007 054 819 A1, which probably forms the closest prior art, discloses a monitoring system having a plurality of monitoring cameras, the image datastreams of the monitoring cameras being conducted, possibly with the interposition of digital image processing algorithms, to a multiplicity of monitors where they are displayed. Furthermore, the monitoring system comprises a workstation for an observer who monitors the image datastreams displayed on the monitors.

### SUMMARY OF THE INVENTION

The safety reporting network according to the invention—also called safety reporting network system or safety reporting network installation—is suitable and/or designed to perform monitoring, particularly with regard to a burglary, an alarm or other criteria.

The safety reporting network comprises at least one local area monitoring network for a monitoring object—or in the operational state—in a monitoring object.

Within the scope of the invention, a monitoring object is preferably understood to be a monitoring area belonging together with regard to content. In particular, the monitoring object is designed as an associated building complex such as, e.g., a hospital installation, an airport installation, a public or private building etc. The local area monitoring network can be or is installed in the monitoring object.

The local area monitoring network is, in particular, a network in which the network subscribers have local area addresses, particularly local area IP addresses. Particularly preferably, the local area monitoring network has a router as an interface. In particular, the monitoring network is designed as an LAN—Local Area Network.

The at least one local area monitoring network has at least one monitoring camera as a network subscriber. In an optionally supplementary manner, the local area monitoring network comprises further monitoring devices such as, e.g., motion detectors or fire detectors.

The monitoring camera comprises a network interface for linking to the local area monitoring network. The monitoring camera comprises a data processing device which is designed to evaluate the monitoring images recorded by the monitoring camera in an automated manner on the basis of digital image processing. The monitoring camera is particularly designed as a so-called “intelligent” monitoring camera. In the case where evaluation produces a peculiarity in the monitoring area according to a set of rules, this peculiarity is treated as an event situation (event). The monitoring camera is designed to output an event notice—also called event notices—on detection of the event situation. The event notice is output into the local area monitoring network of the monitoring camera.

The event notice is defined as a message about an event. The event notice comprises data which characterize the event and can comprise an arbitrary selection of the following data such as, e.g., time of the event (e.g. clock time/date), position of the event (e.g. room X), emitter of the event (e.g. monitoring device Y), type of the event (e.g. burglary, fire, moving object, rise in temperature).

For example, it is possible that the monitoring camera detects moving objects before a static scene background and recognizes an event situation in the case of the presence of a moving object. It is also possible that, according to the set of rules, an event situation is only recognized if the moving object enters an exclusion area or crosses an exclusion line. Further possibilities for detecting event situations by means of digital image processing in monitoring cameras are represented with further references, for example, in the printed document DE 102007053812 of the applicant.

The safety reporting network comprises a first network and a central safety control device, wherein the local area monitoring network is or can be connected to the central safety control device via the first network with regard to data and wherein the event notice is transmitted via the first network to the central safety control device.

The first network can be designed, for example, as a public Internet, but in modified embodiments the first network can also be implemented as a telephone connection or as another data link. Particularly preferably, the first network is designed as a private network which is provided by an ISP (Internet Service Provider).

The safety reporting network also comprises a second network and at least one agent device which is connected to the central safety control device via the second network.

The safety control device is designed particularly preferably as a server which can be reached via the first and the second network. The first and the second network can be designed to be of the same type. However, it is preferred that the second network is implemented as an Intranet so that the agent devices are also arranged in local vicinity of the safety control device.

The safety reporting network is designed to transmit the event notice or an event notice processed on the basis of the event notice as an alarm notice to the at least one agent device. In particular, the event notice is transmitted from the monitoring camera, via the first network, via the safety control device and as an alarm message to the at least one agent device.

The agent devices are preferably designed as workstations, particularly computer workstations, for the monitoring personnel. The agent devices enable the alarm message to be processed by the monitoring personnel.

Within the scope of the invention, it is proposed that the safety reporting network has a plurality of local area monitoring networks, the plurality of the local area monitoring networks being allocated to different monitoring objects.

Whilst it has hitherto been customary that precisely one local area monitoring network is allocated to precisely one safety control device, it is proposed according to the invention to centralize the safety control device or to set up a global safety control device in connection with a multiplicity of local area monitoring networks.

The advantage of the invention can be seen in the fact that the safety control device and the agent devices can be implemented at any position, particularly detached from the local area monitoring network. By this means, a multiplicity of local area monitoring networks and, in consequence, a multiplicity of monitoring objects can be serviced by a central safety control device and the agent devices connected thereto.

The architecture of the safety reporting network enables plant components, particularly so-called hardware, to be saved since it is not necessary to set up a separate safety control device for each local area monitoring network. In addition, the agent devices can also be organized centrally so that agent devices and possibly the monitoring personnel operating the agent devices can also be organized centrally. The central organization has the further advantage that, e.g. training of the monitoring personnel and further development of the agent device, the safety control device etc. can be rapidly implemented.

The advantages of the invention are particularly strongly apparent if the different monitoring objects are arranged spatially separately from one another. Thus, it is easily conceivable, for example, that the monitoring objects can be spaced apart by more than 10 km, preferably more than 20 km and especially more than 50 km from one another. In spite of that, it is possible, via the architecture, to let the monitoring of the various monitoring objects run centrally via the global safety control device.

As an alternative or additionally, the monitoring objects can also be allocated to different types of monitoring objects. Types of monitoring objects are understood to be the different tasks of the monitoring objects. Thus, it is conceivable, for example, that via the central safety control device:

police buildings

fire department installations

airports

railroad stations

storage depots

etc.

are serviced.

The safety control device optionally comprises a management module, the management module being designed to issue accounts for the various monitoring objects and/or groups of monitoring objects which can be allocated to different clients so that the servicing and thus monitoring of the monitoring objects can also be offered to different clients as a central service. In particular, the accounts comprise data relating to the different contact persons, monitoring objects, sets of rules for monitoring and other configuration data.

In a possible development of the invention, the safety control device comprises an event processing module for processing the incoming event notices and for outputting the alarm notice or processed event notices. Particularly preferably, the event processing module accesses a set of rules or the set of rules which is stored in the management module for the respective monitoring object. The set of rules comprises alarm rules, e.g. with regard to an activating time for activating the monitoring, logically combining events etc.

In a preferred embodiment of the invention, the at least one agent device is designed to process and/or evaluate the event notice with user action by monitoring personnel as user. In particular, the agent device is designed to cancel and/or to verify the event notice on the basis of the result of the processing/evaluation.

It is also possible that the agent device is designed to request further information on the alarm notice from the monitoring camera which has delivered the associated event notice. In particular, the agent device is designed to represent the further information and to assess it with user interaction.

As part of a possible development of the invention it is proposed that the safety reporting network has at least one client device, the client device being designed as a mobile terminal, particularly as a mobile telephone. It is also preferably claimed that the agent device has a query module which is designed to send an alarm message and a verification query to the client device and to receive a response of the client device to the verification query. The verification query is a query to the user of the client device whether the alarm is confirmed or discarded as a false alarm.

Particularly preferably, the query module forms an integral component of the agent device. Alternatively or additionally, it is provided to output the alarm message and/or the verification query from the query module automated on the basis of the alarm message and the user interaction.

The advantage of the development can be seen in the fact that the monitoring personnel, as user of the at least one agent device, can include a user of the client device, particularly of the mobile telephone, in the verification of alarm situations. By this means, the monitoring personnel can safeguard themselves and avoid superfluous interventions which can be very expensive depending on the intervening partner (fire department, police, etc.). The monitoring personnel can terminate the alarm more rapidly and with greater reliability. In addition, an end user, as user of the client device and receiver of the alarm message and of the verification query, feels integrated in the process and thus confirmed in the safety system.

In a preferred embodiment of the invention, sending of the alarm message and of the verification query can be triggered by user interaction. In this embodiment, it is not a matter of a parallel signal path, an alarm notification being sent both to the agent device and to the client device, but of a serial signal path, particularly a signal chain, wherein a user interaction must take place in the signal path firstly in the agent device in order to trigger the sending of the alarm message and of the verification query to the client device. The advantage of this embodiment can be seen, in particular, in that the end user, as user of the client device, only receives alarm messages and verification queries of event situations which have already been prechecked by user interaction in the agent device, particularly manually, so that now only highly relevant event situations are forwarded to the client device in the form of alarm messages and verification queries.

In a preferred embodiment, it is provided that the alarm message contains some or all of the following data:
Details on the event forming the basis of the alarm message, particularly time of the event (e.g. clock time/date), position of the event (e.g. room X), emitter of the event (e.g. monitoring device Y), type of the event (e.g. burglary, fire, moving object, rise in temperature).
Images for the event forming the basis of the alarm message, particularly a still frame or single frame of the event.

In a preferred development of the invention, the client device is designed to send a verification information item to the agent device in response to the verification query. In particular, the response takes place with user interaction by way of the end user.

In a preferred practical embodiment of the invention, the client device has software, particularly an application, which is designed as a program to display, and have selected by the end user, a selection of verification answers on a screen of the client device. For example, three different verification answers are displayed on the screen of the client device which can be selected by means of touch screen or a different human-machine-interface and are sent as verification information to the agent device.

In a possible embodiment of the system architecture, it is provided that the local area monitoring network can be and/or is connected to the safety control device via one or the first network, the safety control device can be and/or is connected to the at least one agent device via one or the second network, respectively, and the client device can be and/or is connected to the safety control device via a third network. Particularly preferably, the safety reporting network is designed for sending the verification query from the agent device via the second network to the safety control device and subsequently from the safety control device via the third network to the client device. The third network can be designed to be of the same type as the first network or the second network, respectively, but it can also be a telephone link, in particular.

In a preferred embodiment or a further development of the invention, the verification query and/or the alarm message is transmitted via the so-called push notification technology of smart phones as an embodiment of mobile telephones. Using the push notification technology has the advantage that the user of the client device does not have to have the corresponding software or application continuously activated, rather that the software or application is activated by the push notification service of the client device as required, particularly on reception of the push notification.

In a preferred development of the invention, it is provided that, together with the alarm message and/or the verification query, monitoring frame information relating to the monitoring event is transmitted to the client device so that first image data are loaded in a first type of display for displaying the monitoring event.

The monitoring camera is designed to output monitoring frame information relating to a monitoring event. The monitoring frame information comprises one or more monitoring frames, the monitoring frames having a quality level. The quality level can relate preferably, on the one hand, to a resolution of the monitoring frames and on the other hand, the quality level can relate to a compression of the monitoring frames. Thus, a low resolution and/or high compression usually lead to a low quality level and a high resolution and/or low compression lead to a low quality level of the monitoring frames. Furthermore, the quality level can be influenced by the spatial resolution, grayscale resolution of the pixels, color-level, grayscale level or black/white display, size of the image section.

The safety reporting network is designed to transfer the monitoring frame information relating to the monitoring event to the at least one agent device and/or to the at least one client device—also called user device in summary in the text which follows. In particular, the monitoring frame information is transferred from the monitoring camera, via the first network, via the safety control device and the further network to the user device.

Transmission is carried out in such a manner that first image data for displaying the monitoring event are loaded in a first type of display in the agent device. The first image data are thus sufficient to display the monitoring event in the first type of display on the user device.

As an optional addition it is proposed that the safety reporting network is designed that further monitoring frame information relating to the monitoring event are loaded automated and/or automatically so that second image data for displaying the monitoring event in a second type of display are loaded, the second image data having more information content and/or a greater volume of data than the first image data.

The addition is based on the thought that the transmitting networks are often limited in bandwidth. It is particularly in the case of long transmission paths that it can be expected that at least one serially arranged data transmission section has only a narrow bandwidth so that the monitoring frame information necessary for displaying the monitoring event must not be of an arbitrary size. Against this background, the invention proposes that initially first image data are loaded into the user device in order to display the monitoring event with a low information content and/or a small volume of data. This step must be implemented rapidly so that the monitoring event can be displayed promptly on the user device. In a second step, further monitoring frame information is loaded so that second image data are present in the user device, the second image data permitting a second type of display which contains more details about the monitoring event.

It is then possible that the second image data are independent of or separate from the first image data. However, it also lies within the scope of the addition that the first image data are supplemented by progressively reloading further monitoring frame information in order to generate the second image data in this manner.

In a preferred embodiment of the invention, the second image data have a greater number of monitoring frames than the first image data. Particularly preferably, it is provided that the first image data only represent a single frame and the second image data show a video sequence, particularly a clip, that is to say a sequence of image data following one another in time. In this embodiment, the single frame can be displayed firstly and very rapidly on the user device. While the single frame can already be checked by a user, particularly a monitoring personnel or by a control person, further monitoring frame information is reloaded. As a result, a video sequence or a clip of the monitoring event is available promptly which, for example, can be advanced and rewound. The video sequence has a higher information content but, at the same time, a greater volume of data. In a practical embodiment, a single frame is transmitted in jpg compression, e.g., with a size of 20 kB, e.g. within a time of one second as first image data. As second image data, a video sequence is transmitted which represents, for example, 5 seconds before and after the event and which, for example, has a size of between 100 and 5000 kB. The transmission of the second image data takes, for example, 5 to 30 minutes—particularly in the case of a narrow transmission bandwidth. By means of the progressive information build-up of the safety reporting network, it is preferably achieved that the most informative image data in dependence on the bandwidth of the interconnected networks are available at any time to the user.

In a possible development or alternative of the invention, the second image data have a greater resolution and/or less compression than the first image data. Apart from or additionally to the number of monitoring frames, the image data can thus differ with regard to the quality level, that is to say especially with regard to the resolution and/or strength of compression. In this context, it is assumed that due to stronger compression, the accuracy of the image data and thus the quality level also decreases.

In a possible development of the invention, the safety reporting network can be designed in such a manner that further quality levels of image data are loaded. Within the scope of the invention, it is thus possible that third, fourth etc. image data are also loaded for display in a third, fourth, etc. type of display. However, it must be emphasized that in a general representation, the (n)th image data have more information content and/or a greater volume of data than the (n−1)th image data. In this manner, the monitoring frame information is loaded progressively from the monitoring camera to the user device until it is present there with the highest possible resolution. In the general representation, n can be =2 and (n−1) can be =1.

In particular, it can be provided that third image data comprise the original data of the monitoring event of the monitoring camera. In a preferred embodiment, it can thus be provided that in a first type of display, a still frame is shown; as soon as the transmission of the still frame is ended, the further monitoring frame information for the second type of display is then reloaded automatically, particularly in the form of a video sequence. As soon as the second image data are complete, the still frame is exchanged in automated manner for the video sequence so that the monitoring personnel or the user can operate in advance and rerun in time around the monitoring event. As soon as the loading of the further monitoring frame information for the second type of display is ended, further monitoring frame information for the third type of display is then reloaded. The third type of display relates to the original data and, therefore, has the greatest volume of data and the highest quality. As soon as the original data are loaded, the second type of display is exchanged in automated manner for the third type of display so that the monitoring personnel or the user can now operate an advance and rewind in a high quality.

In a possible development of the invention, it is proposed that the safety reporting network comprises the client device or a further client device. The client device is designed as a mobile telephone, especially as a smart phone. In particular, the mobile telephone comprises a screen on which the image data can be displayed. The mobile telephone is or can be linked in respect of data especially via a public telephone network.

The client device comprises at least one sensor for picking up environmental data. The sensor is designed particularly as a camera, especially as a video camera, or as a microphone. The environmental data are image data of the environment of the client device or recordings of acoustic signals in the environment of the client device.

The client device comprises at least one input device for inputting commands. The input device can be designed as one or more mechanical or virtual operating buttons, as a touch-sensitive screen or also as a voice input device for inputting acoustic commands.

The client device also comprises a control device which is designed with regard to programming and/or circuitry to record or further record in response to an input of at least one start command as one of the commands, environmental data of an event situation by means of the sensor and to convey the environmental data into the safety reporting network. The control device thus interprets the start command as a trigger for recording or for continuing the recording of the environmental data of the event situation. Particularly preferably, a software, particularly an application which implements the said functions and subsequent functions by programming these, is installed on the client device.

In particular, the event situation is an environmental state which renders a notice to the safety reporting network as significant. The event situation can be, for example, the detection of strange persons in a monitoring area or the outbreak of a fire.

In the context of the development, it is proposed that the start command is designed as a quickstart command, a mobile event notice being delivered to the safety reporting network after input of the quickstart command. In addition, the environmental data of the event situation are recorded or still recorded and transmitted at the same time or with a short time offset of less than 5 seconds, preferably less than 3 seconds and especially less than 1 second, into the safety reporting network. In particular, the environmental data of the event situation are transmitted together with the mobile event notice into the safety reporting network.

After the input of the quickstart command, the three actions are thus performed independently or automatically, particularly synchronously and overlapping in time, especially in a time interval of less than 5 s, preferably less than 3 s and especially less than 1 s:
1. Transmitting the mobile monitoring notice
2. Recording the event situation (of the monitoring area with the event situation, respectively) with the sensor
3. Immediate transmission of the environmental data

The mobile event notice is defined as a message about the event situation. The mobile event notice comprises event data which characterize the event situation and can comprise an arbitrary selection of the data following such as, e.g., time of the event situation (e.g. clock time/date), position of the event situation (e.g. GPS coordinates of the client device with an integrated GPS sensor), emitter of the event notice (e.g. client device Y/telephone number), type of event situation (e.g. burglary, fire, moving object, rise in temperature).

In addition, the detection of the event situation is not performed by an evaluating device but by the user of the client device. As soon as the user of the client device recognizes an event situation, a mobile event notice is recorded via the quickstart command, on the one hand, and, on the other hand, the current environmental data of the event situation are recorded and transmitted at the same time or as quickly as possible into the safety reporting network. The short time offset mainly results from technical considerations since it is often necessary for transmitting environmental data to temporarily store the environmental data. It is also possible that the environmental data are compressed in order to accelerate the transmission and this procedure also results in a short time offset.

The advantage of the development is that the user with the client device can transmit a mobile event notice at the same time, e.g. as an emergency call, together with the environmental data of the event situation into the safety reporting network. In this context, it is not necessary that an evaluating device first analyzes the environmental data in an automated manner. As a result, the mobile event notice, together with the environmental data, can be fed more rapidly into the safety reporting network which is advantageous, for example, if the user subsequently gets into a crowded situation. By means of the client device, it is also possible to deliver the mobile event notice with a high degree of process reliability without having to rely on the fact that an evaluating device evaluates the environmental data correspondingly correctly and recognizes the event situation. In particular, it is possible that the user of the client device detects an event situation by means of human intuition but the evaluating device does not recognize it due to the evaluating algorithms. Sending the mobile event notice off together with the environmental data immediately thus possibly even increases the safety of the user in hazard situations.

In a preferred embodiment of the invention, the quickstart command is designed as a wipe command on a touch-sensitive screen as the input device. The wipe command is defined, in particular, in such a manner that it cannot be produced by an accidental contact. Particularly preferably, the wipe command is defined with at least one change in direction. Thus, it is conceivable, for example, that a large L must be drawn on the screen or the wipe command must be entered even with two or three changes in direction, e.g. like a U or a W. It is also possible that the quickstart command is designed as a “swype” input wherein more than two, three, four or five positions must be traced with a continuous movement on the touch-sensitive screen, the positions of three successive points not being located on a common straight line.

Since the transmission of the mobile event notice together with environmental data can lead to an intervention of the safety reporting network in the monitoring area of the mobile telephone, that is to say to the activation of protective or countermeasures and/or to rescue and/or safety forces such as, e.g., police or fire department, being contacted, this embodiment ensures that the quickstart command cannot be input accidentally. Alternatively or additionally, the quickstart command is input by an independent separate key (emergency key). This embodiment has the advantage that the probability of wrong inputs is reduced further, but it is not possible in this embodiment to use commercially available mobile telephones.

The mobile event notice is preferably designed to be similar or even identical to the event notice with respect to data. The event notice is defined as a message about an event.

In this context, it is particularly preferred that the event processing module of the safety control device is designed to process the incoming event notices and mobile event notices and to output an alarm notice in dependence on a set of rules. It is a particular advantage of the embodiment that event notices and mobile event notices can be processed in the same way by the safety control device. By means of this architecture, it is thus possible to include the client device with respect to data in the safety reporting network analogously to the other monitoring devices as a further monitoring device.

### BRIEF DESCRIPTION OF THE DRAWINGS

Further features, advantages and effects of the invention are obtained from the subsequent description of preferred exemplary embodiments of the invention and of the attached figures, in which:

FIG. 1 shows a block diagram of a safety reporting network as one exemplary embodiment of the invention;

FIGS. 2a,b,c show a diagrammatic flowchart for explaining the method of the progressive information transmission;

FIGS. 3a,b,c show a diagrammatic flowchart for illustrating the generation of the monitoring frame information for the progressive buildup of information;

FIG. 4 shows an exemplary representation of an alarm message on an agent device of the safety reporting network in FIG. 1;

FIG. 5 shows a block diagram of a safety reporting network as a further exemplary embodiment of the invention;

FIG. 6 shows a block diagram of a safety reporting network as a further exemplary embodiment of the invention.

### DETAILED DESCRIPTION

Identical or mutually corresponding components, sizes, signals etc. are in each case provided with identical or mutually corresponding reference symbols in the figures.

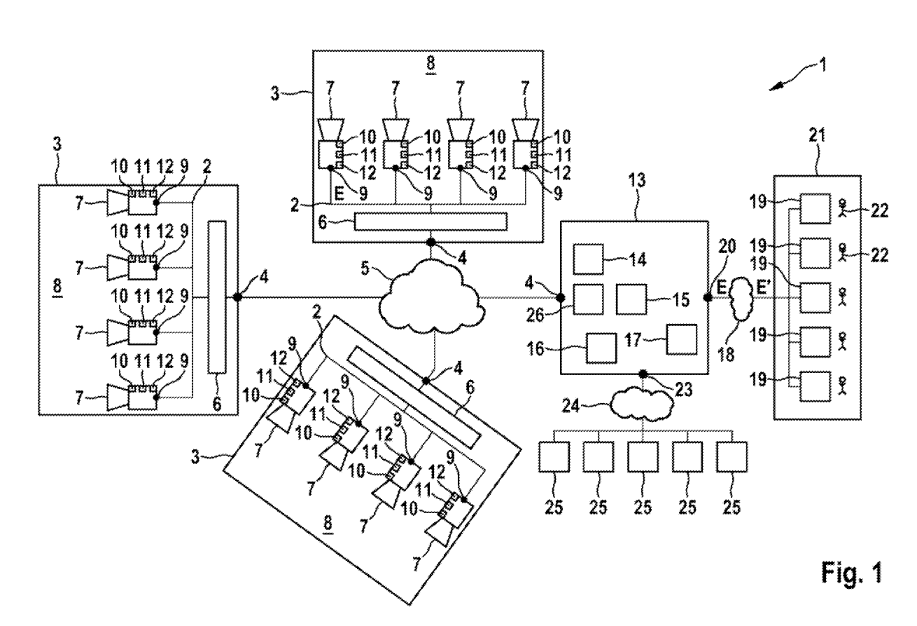

FIG. 1 shows in a block diagram a safety reporting network 1 as one exemplary embodiment of the invention. The safety reporting network 1 comprises a number of local area monitoring networks 2 which are installed in different monitoring objects 3.

Each of the local area monitoring networks 2 is designed as a local area network and defines one or at least one local area domain. The local area monitoring network 2 is implemented, e.g., as an LAN or as a WLAN. Each of the network subscribers in the local area monitoring network 2 has a local IP address. The local area monitoring network 2 has an interface 4 to a first network 5, a router 6 being interconnected before the interface 4. In particular, the local area monitoring network 2 is an exclusively private network and the first network 5 is a tier-3 or tier-2 or tier-1 network. Each of the local area monitoring networks 2 comprises at least one monitoring camera 7 which is designed to monitor a monitoring area 8 in the monitoring object 3.

The monitoring objects 3 are arranged spatially independently of one another and can be positioned, for example, with a distance of greater than 10 km, 20 km or greater than 50 km from one another. They can be monitoring objects 3 of different companies as clients. These are dealt with by means of different accounts in the safety reporting network 1. They can also be monitoring objects 3 of different types. Thus, it is possible that a monitoring object 3 is an airport, another monitoring object 3 is a railroad station, a further monitoring object 3 is a storage depot etc. In the safety reporting network 1, arbitrary monitoring objects 3 can be added. The monitoring objects 3 can be understood to be, in particular, logical units.

The monitoring cameras 7 have in each case a network interface 9 via which the monitoring cameras can communicate with the local area monitoring network 2. The monitoring cameras 7 are designed as intelligent monitoring cameras 7 which comprise in each case a data processing device 10 and a local storage device 11. The monitoring cameras 7 are designed to process the recorded monitoring frames in the data processing device 10 with the aid of digital image processing and to store monitoring frames in the local storage device 11. Furthermore, the monitoring cameras 7 comprise a set of rules 12 having alarm rules so that the monitoring cameras 7, after analysis of the monitoring frames by the data processing device 10, can deliver an event notice E into the local area monitoring network 2.

The first network 5 is based on the Internet protocol and can be designed as a public Internet in a first alternative embodiment. Alternatively, the first network 5 is designed as a private IP network, all interfaces 4 of the first network 5 being allocated exclusively to the private IP network and the private IP network, in particular, being separated from the public Internet with respect to data. Alternatively, the first network 5 can also be designed as an LAN (local area network) or as a WAN (wide area network). In particular, the first network 5 implements a reliable TCP link.

The safety reporting network 1 comprises a particularly central or global safety control device 13 which is designed, e.g., as a server or as a server farm. The safety control device 13 is connected via one of the interfaces 4 to the first network 5 and thus to the local area monitoring networks 2 of the different monitoring objects 3.

The safety control device 13 comprises a management module 14, an event processing module 15, a database for event and sensor data 16, an archive 17 for monitoring frames of the monitoring camera 7 and an infrastructure management module 26 for registering the monitoring devices, particularly the monitoring cameras 7.

The management module 14 is designed to manage different clients having different monitoring objects 3. The clients are, in particular, economically or legally independent companies which use the safety reporting network 1 for letting their monitoring objects 3 be monitored. In the management module 14, the monitoring objects 3 to be monitored and the configuration data of the local area monitoring networks 2 of the monitoring objects 3 are thus deposited for each client. Furthermore, data for monitoring the monitoring objects 3 are deposited such as, e.g., alarm and notification rules, contact persons, details of contact persons such as, e.g., e-mail, telephone number, address etc. The management module 14 allows arbitrary monitoring objects 3 of new or preexisting clients to be integrated flexibly in the safety reporting network 1.

The safety control device 13 also comprises the event processing module 15 which processes and evaluates the event notices E of the monitoring cameras 7 or the mobile event notices MUE, still described in the text which follows, according to a set of rules. In particular, the event processing module 15 accesses the alarm rules in the management module 14 in which they are specified individually and/or client-individually per monitoring object 3. The alarm rules comprise, for example, an activation schedule for monitoring, logically linking events, executing a number of actions etc. The event processing module 15 outputs a processed event notice as alarm notice E as a result of the processing.

Furthermore, the safety control device 13 comprises the database 16 for depositing and logging all events and sensor data. Additionally, the safety control device 13 has the archive 17 for original monitoring frames, not all monitoring frames being deposited in the archive 17 for storage space reasons but only monitoring frames which are linked to an event.

The safety control device 13 is connected with respect to data to one or more agent devices 19 via an output interface 20 via a second network 18.

The second network 18 can correspond to the first network 5. Alternatively, it is possible that the second network 18 is designed as an Intranet or as another variant of the first network 5. However, it can also be designed as a private IP network.

The agent devices 19 altogether form a control station 21 or a monitoring center. In the control station 21, a plurality of such agent devices 19 are arranged in most cases so that the control station 21 can be scaled in dependence on the number and size of the monitoring objects 3. The agent devices 19 are designed, in particular, as workstations for monitoring personnel 22.

The agent devices 19 receive the event notice E, or the event notice E′ processed via the event processing module 15, or the alarm notice A, the notices E, E′, A being displayed on the agent devices 19 so that they can be processed by the monitoring personnel 22. The agent devices 19 are designed to implement different procedures in the processing by the monitoring personnel 22.

Thus, it is possible that the monitoring personnel 22 cancels the notice E, E′, A when it is estimated to be a false alarm by the monitoring personnel 22. Furthermore, it is possible that the notice E, E′, A is verified as an alarm, an external alarm being triggered optionally via the control station 21 or the safety control device 13 after verification of the alarm by the monitoring personnel 22. Thirdly, it is possible that the agent devices 19 enable further information to be requested from the monitoring cameras 7 relating to the notice E, E′, A, or to be loaded automatically.

The safety control device 13 has a further output interface 23 which is connected to a third network 24. The third network 24 can be designed to be of the same type as the first network 5 or the second network 18, respectively, but can be, in particular, also a telephone link or a cableless link. Via the third network 24, a plurality of client devices 25 can be reached which are designed, for example, as portable/smart phones (generally mobile terminal).

The agent device 19 receives additionally to the event notice E, E′ or the alarm message A monitoring frame information relating to the monitoring event. In this context, an area of conflict arises since, on the one hand, the monitoring frame information is to be transmitted as rapidly as possible so that an event notice/alarm message can be processed as promptly as possible by the agent devices 19. On the other hand, the monitoring frame information should be as accurate as possible so that the evaluation by the monitoring personnel 22 at the agent device 19 is as precise as possible. In this context, a progressive transmission of information of monitoring frame information from the monitoring camera 7 to the agent device 19 or—with the same motivation—to the client devices 25 is selected.

The monitoring frame information is transmitted in three different quality levels Q1, Q2 and Q3 in the exemplary embodiment shown.

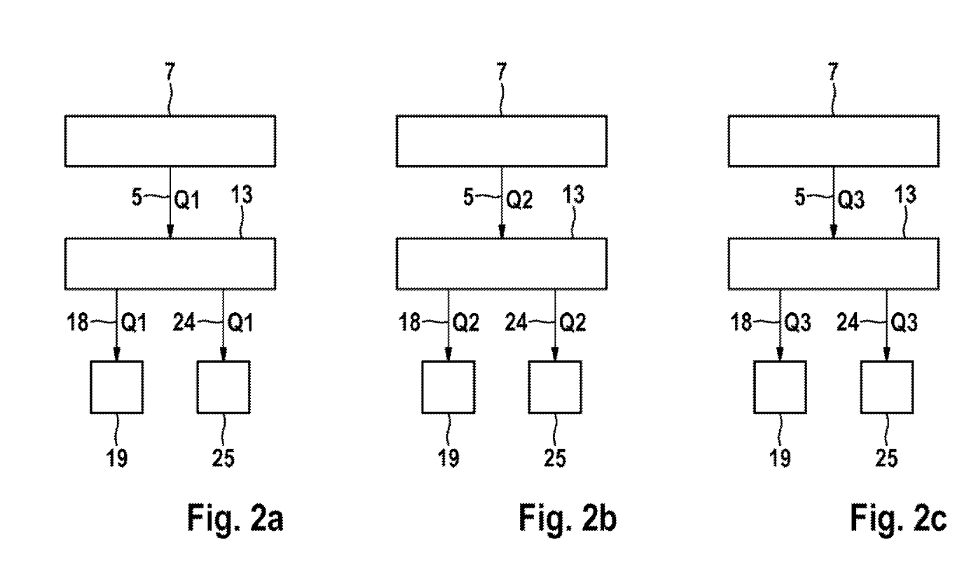

FIGS. 2a, b, c show diagrammatically the transmission of the monitoring frame information. FIG. 2a shows that—coming from the monitoring camera 7—monitoring frame information is transmitted in a first quality level Q1 via the first network 5 to the safety control device 13. From there, the monitoring frame information Q1 is forwarded optionally to the agent devices 19 or to the client devices 25, via the second network 18 or the third network 24, respectively.

The monitoring frame information of the first quality level Q1 comprises first image data which are designed for displaying the monitoring event in a first type of display. The first type of display is a still-frame display and the first image data are a single frame, e.g. in a jpg format, of the monitoring event. Such a jpg file has a file size of 30 to 50 kB and can be transmitted rapidly even with narrow network bandwidths. It is thus possible that the monitoring event is displayed in the first type of display already after a period of less than 5 seconds, e.g. within one second, from the triggering of the monitoring event.

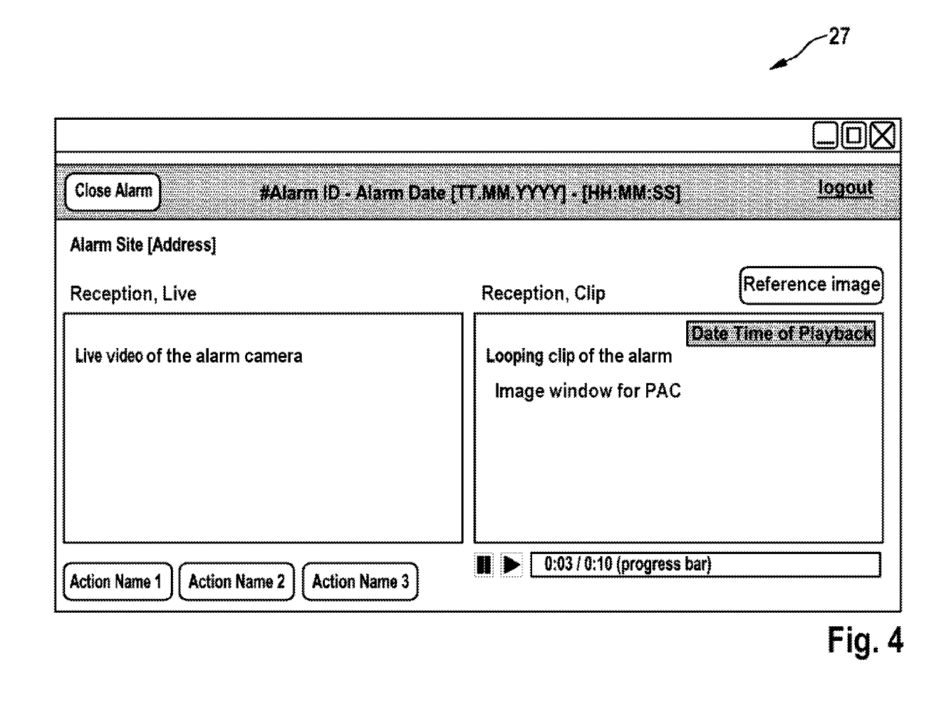

FIG. 4 shows in a diagrammatic representation the screen display 27 of a monitor of one of the agent devices 19. The screen display 27 shows an alarm notice A, data relating to the alarm notice A such as, e.g. the date, the clock time, the address of the alarm-triggering device, being shown in the upper area. The monitoring frame information of the first quality level Q1 is shown as a still frame in the first type of display on the left-hand side.

Whilst the monitoring personnel 22 is already able to study the monitoring frame information of the first quality level Q1, a video sequence having low resolution/high compression is already transmitted in the background as further monitoring frame information in a second quality level Q2 to the user device 19 or the client device 25, respectively, as is shown in FIG. 2b. The further monitoring frame information allows the monitoring event to be displayed as a video sequence or a clip, a range of +/−5 seconds being provided, for example, around the actual monitoring event. As soon as the further monitoring frame information is loaded, the still frame is exchanged for the video sequence as the second type of display so that the monitoring personnel 22 can analyze the monitoring scene more accurately at the time of the monitoring event from this moment onward. The video sequence has a file size of some 100 kB so that the image data for the second type of display are available within a few minutes, especially less than 5 minutes, even in the case of narrow transmission bandwidths.

As is found, in particular, from FIG. 2c, the monitoring frame information Q3 is downloaded in a third step in a third quality level which corresponds to the original data of the monitoring event. Due to the great volume of data, e.g. more than 5 MB, the transmission of the monitoring frame information Q3 of the third quality level can take longer than some minutes so that they are available only after some time. The monitoring frame information Q3 in the third quality level can be filed, for example, or used for a reference in a legal process.

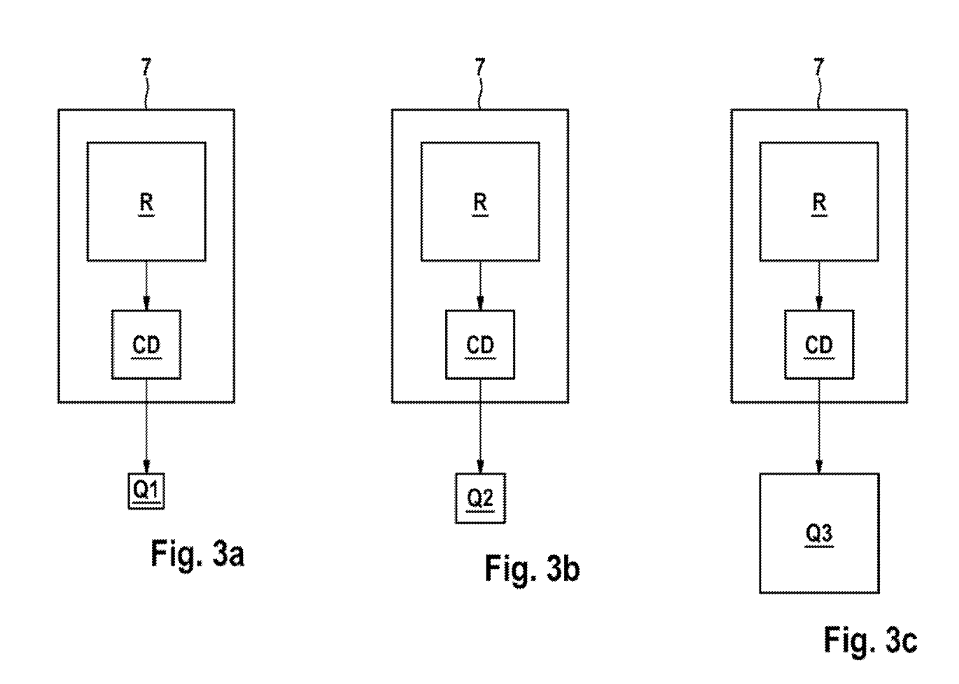

FIGS. 3a, b, c illustrate the generation of the monitoring frame information in the different quality levels Q1, Q2, Q3 in a diagrammatic representation. In each case, the monitoring camera 7 is shown which firstly records the monitoring frames in a raw data format R. In a first coding step, the image data can be coded with a minimum or no loss of quality. In particular, the coding is carried out in accordance with the mpeg4 and/or H.264 standard. Starting from the coded image data CD, monitoring frame information Q1, Q2, Q3 is generated. In this embodiment, the monitoring camera 7 forms a transcoder device.

It can be provided that the safety reporting network 1 has a device for determining or estimating the available or usable data transmission rates between monitoring camera 7 and agent device 19 or client device 25, respectively, as user devices. For example, the device can estimate the available or usable data transmission rate from a filling level of an output buffer of the monitoring camera 7. If the output buffer has a high filling level, it is assumed that the data transmission rate is low since the filling level cannot be reduced. If, in contrast, the filling level is low, this points to a high data transmission rate since the output buffer can be emptied more rapidly than filled with new data. The safety reporting network 1 and particularly the monitoring camera 7 are designed to select a quality level or to adapt the quality levels in dependence on the available or usable data transmission rate.

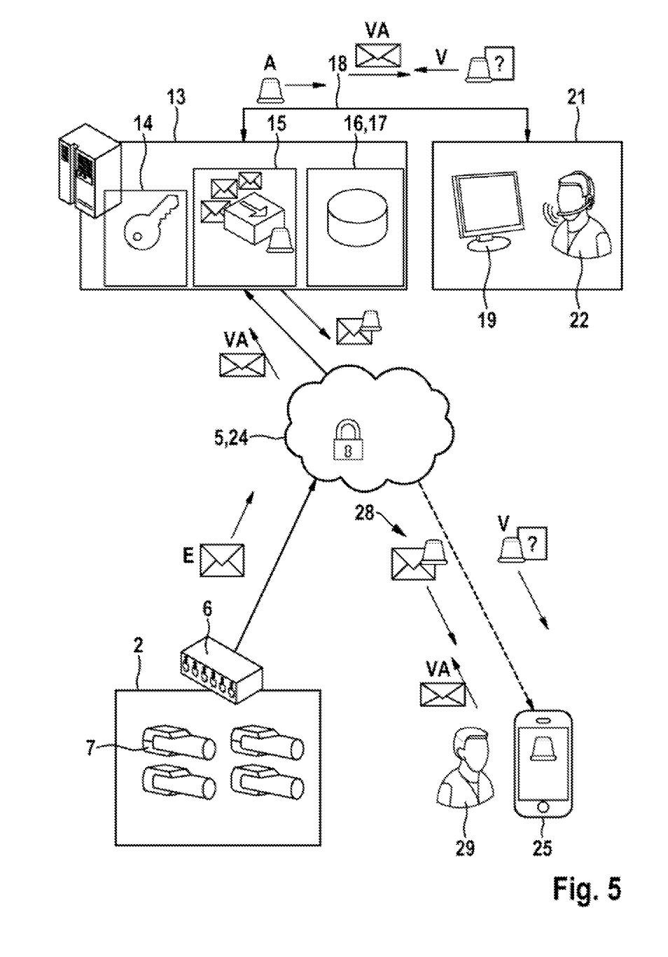

FIG. 5 shows in a diagrammatic representation the safety reporting network 1 and its processes during the processing of a monitoring event. FIG. 5 represents a possible embodiment of the safety reporting network 1.

In the case of a monitoring event, detected by one of the monitoring cameras 7, an event notice E is sent from the associated local area monitoring network 2 to the safety control device 13 as has already been explained in conjunction with FIG. 1. The event notice E is processed by the event processing module 15 which sends an alarm notice A to the control station 21, especially to one of the agent devices 19, in dependence on the set of rules.

The alarm notice A is processed there by the monitoring personnel 22 in a workflow predetermined or stored, in particular. As part of the workflow, it is possible that a verification query V is triggered by a query module 33 of the agent device 19 by means of user interaction and/or manually. This verification query V again runs via the safety control device 13 and is transmitted from there to one of the client devices 25 together with an alarm message 28. In the exemplary embodiment shown, the first and the third network 5, 24 are designed as an LAN/WAN. Both the event notice E and the verification query V and the alarm message 28 are transmitted via secure TCP links.

For example, the alarm message 28 or the verification query V are designed as a so-called push notification. The push notification are messages which are indicated or reported on the client device 25 directly and without user interaction. The alarm message 28 and/or the verification query V contain ongoing detailed information about the monitoring event. For example, the time of the event at the monitoring camera 7, time of the acceptance of the alarm notice A in the control station 21, the triggering device, the monitoring object 3, a video image or a video sequence and/or a live audio recording are transmitted.

A typical field of application for one of the verification queries V is when a person has been sighted in the monitoring object 3 but the monitoring personnel 22 cannot clarify unambiguously whether this is a trespasser or a known person. In this case, the monitoring personnel 22 can request further instructions from a user of the client device 25 via the verification query V.

The verification query V provides a selection of a number of verification responses VA. The verification responses VA are designed optionally as a part of the verification query V or provided on the client device 25. For processing the verification query V and for selecting the verification responses VA, a corresponding software or app is installed on the client device 25, particularly designed as a mobile telephone. For example, various options are indicated on the client device 25 by means of software buttons. The user 29 of the client device 25 selects a response from the options, e.g. false alarm or alarm case etc. The selected verification response VA is sent back to the safety control device 13 and/or the control center 21, particularly the triggering agent device 19, via the same signal path. The safety control device 13 or the agent device 19 evaluates the alarm notice A in accordance with the verification response of the user 29.

It is optionally possible that a confirmation dialog is inserted on the client device 25 such as, e.g.:
“You have evaluated the alarm as uncritical. No intervention is initiated.”
“Ok/back”,

### Or

“You have evaluated the alarm as critical. Please confirm immediate intervention.”
“Ok/back”

The verification response VA of the user 29 is sent to the agent device 19 and thus to the monitoring personnel 22.

If the user 29 does not answer within a defined time, the verification query V expires and the monitoring personnel 22 must evaluate or reset the alarm in the conventional manner.

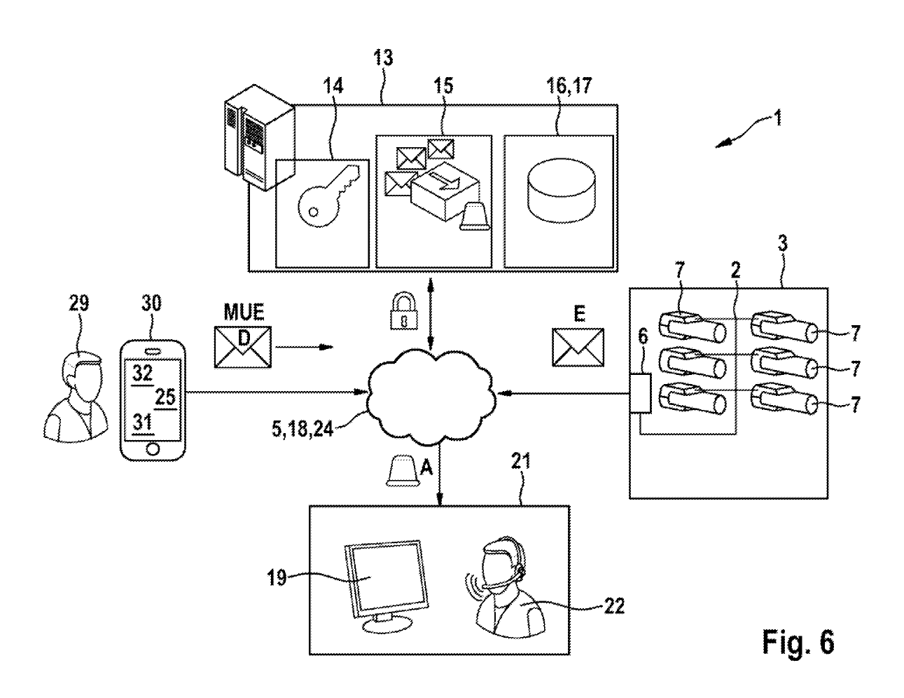

FIG. 6 shows the safety reporting network 1 in a variant as a further exemplary embodiment. In the same manner as the safety reporting network 1 in FIGS. 1 and 5, the safety reporting network 1 in FIG. 6 has the safety control device 13, at least one local area monitoring network 2, the control station 21 and at least one client device 25. In distinction from the preceding safety reporting network 1, the different components of the safety reporting network 1 are connected via an LAN/WAN as the first, the second and the third network 5, 18, 24 with respect to data. The LAN/WAN in FIG. 6 or in the preceding figures can also be designed as the public Internet.

FIG. 6 is used for illustrating the functionality of a mobile user event of the client device 25. In this embodiment, the client device 25 is designed as a mobile telephone and connected to the safety reporting network 1 via the mobile radio network—at least in a serial intermediate section in the link to the LAN/WAN 5, 18, 24—with respect to data.

The client device 25 comprises at least one sensor 30 which is designed as a connected or integrated camera, particularly a video camera. By means of the sensor 30, it is possible to record environmental data D in the form of monitoring frame information or image data from the environment of the client device 25. Furthermore, the client device 25 comprises an input device 31 which allows commands to be input into the client device 25. In this exemplary embodiment, the input device 31 is designed as a touch-sensitive screen.

In addition, the client device 25 has a control device 32 which implements that, in response to an input of a quickstart command into the input device 31, environmental data D are picked up by means of the sensor 30 or a recording is continued. The environmental data D are transmitted together with a mobile event notice MUE into the safety reporting network 1 and forwarded into the safety control device 13 for further processing.

The functionality of the mobile user event allows the user 29, via the quickstart command as a command combination, to start both the recording of the environmental data D and the sending out of the mobile event notice MUE and the transmission of the environmental data D. Recording of the environmental data D, sending out the mobile event notice MUE and beginning the transmission of the environmental data D are carried out in a narrow time interval of less than 5 s or less than 2 s. With the input of the quickstart command, the recording of the environmental data is immediately continued and the event notice is also immediately delivered. The environmental data D are transmitted immediately, especially only with a time offset which is technically necessary.

One possible field of application of the mobile user event functionality is the client device 25 being carried by a mobile monitoring personnel (not shown). In the case where the mobile monitoring personnel detects a suspicious situation as an event situation, e.g. during an inspection tour, it is possible that the client device 25 is activated by the quickstart command and, on the one hand, feeds the mobile event notice MUE and, on the other hand, the environmental data D into the safety reporting network. These data are forwarded to the safety control device 13 and possibly to the control station 21. The mobile event notices MUE are there processed further in the same manner as the event notices E. The client device 25 thus extends the safety reporting network 1 by a mobile monitoring device which blends seamlessly into the software architecture.

The quickstart command can be designed, e.g., as a wipe command on the input device 31 designed as touch-sensitive screen.

In particular, it is possible that after an alarm notice A based on the mobile event notice MUE has been received, a verification query V is sent to the same or another client device 25 in order to obtain a verification on site. For the description of the verification query, reference is made to FIG. 5.

1. A safety reporting network (1), the network comprising:
at least one local area monitoring network (2) of a monitoring object (3), the at least one local area monitoring network (2) having at least one monitoring camera (7), the monitoring camera (7) being designed to output an event notice (E),
having a first network (5) and a central safety control device (13), the local area monitoring network (2) being connected to the central safety control device (13) via the first network (5) with respect to data, the event notice (E) being transmitted via the first network (5) to the central safety control device (13),
a second network (18) and at least one agent device (19) which is connected to the central safety control device (13) via the second network (18), the event notice (E), or an event notice (E′) processed on the basis of the event notice, being transmitted as alarm notice (A) to the agent device (19),
wherein the safety reporting network (1) has a plurality of local area monitoring networks (2), the plurality of local area monitoring networks (2) being allocated to different monitoring objects (3).

2. The safety reporting network (1) as claimed in claim 1, characterized in that the different monitoring objects (3) are spatially separate from one another and/or allocated to different types of monitoring object and/or clients.

3. The safety reporting network (1) as claimed in claim 1, characterized in that the central safety control device (13) has a management module (14) which manages accounts for different monitoring objects (3) and/or groups of monitoring objects (3).

4. The safety reporting network (1) as claimed in claim 1, characterized in that the agent device (19) is designed for processing and/or evaluating the alarm notice (A) with user interaction by a monitoring personnel (22).

5. The safety reporting network (1) as claimed in claim 1, characterized in that the agent device (19) is designed to request further information on the alarm notice (A) from the monitoring camera (7) which has delivered the associated event notice (E), in order to evaluate the alarm notice (A).

6. The safety reporting network (1) as claimed in claim 1, characterized by at least one client device (25), the client device (25) being designed as a mobile telephone, the agent device (19) having a query module (33) which is designed to send an alarm message (28) and/or a verification query (V) to the client device (25) and to receive a response of the client device (25) to the verification query (V).

7. The safety reporting network (1) as claimed in claim 6, characterized in that the sending of the alarm message (28) and/or of the verification query (V) can be triggered by user interaction by a monitoring personnel.

8. The safety reporting network (1) as claimed in claim 6, characterized in that the client device (25) is designed to send a verification response (VA) to the agent device (19) in response to the verification query.

9. The safety reporting network as claimed in claim 1, characterized in that the monitoring camera (7) is designed to output monitoring frame information relating to a monitoring event, the monitoring frame information comprising one or more monitoring frames, the monitoring frame information being transferrable via the safety control device (13) to the at least one agent device (19) and/or client device (25)—jointly called user device (19, 25) in the text which follows—the safety reporting network (1) being designed for monitoring frame information relating to the monitoring event being loaded in the user device (19, 25) so that first image data for displaying the monitoring event are loaded in a first type of display, the safety reporting network (1) being configured for further monitoring frame information relating to the monitoring event being loaded automated and/or independently so that second image data for displaying the monitoring event are loaded in a second type of display, the second image data having more information content and/or a greater volume of data than the first image data.

10. The safety reporting network (1) as claimed in claim 6, characterized in that the second image data have a greater number of monitoring frames than the first image data.

11. The safety reporting network (1) as claimed in claim 9, characterized in that third image data for displaying the monitoring event in a third type of display comprise the original data of the monitoring event by the monitoring camera (7).

12. The safety reporting network (1) as claimed in claim 1, characterized by the or a further client device (25), the client device (25) being designed as a mobile telephone, having at least one sensor (30) for picking up environmental data (D), having at least one input device (31) for inputting commands and having at least one control device (32), the control device (32) being designed to record, in response to an input of at least one start command as one of the commands, environmental data of an event situation by means of the sensor (30) and to convey these environmental data into the safety reporting network (1), the start command being designed as a quickstart command, the environmental data (D) of the event situation being recorded, after input of the quickstart command, and at the same time or with a short time offset of less than 5 s being conveyed into the safety reporting network and a mobile event notice (MUE) being delivered.

13. A method for operating the safety reporting network (1) as claimed claim 1, characterized in that a number of local area monitoring networks (2) are serviced by a common central safety control device (13).

14. The safety reporting network (1) as claimed in claim 12, wherein the short time offset is less than 3 s.

15. The safety reporting network (1) as claimed in claim 12, wherein the short time offset is less than 1 s.
